(19) United States
(12) Patent Application Publication
(10) Pub. No.: US 2018/0010460 A1
(43) Pub. Date: Jan. 11, 2018

(54) TURBINE BLADE, TURBINE, AND METHOD FOR PRODUCING TURBINE BLADE

(71) Applicant: MITSUBISHI HEAVY INDUSTRIES, LTD., Tokyo (JP)

(72) Inventors: Koji TSUKIMOTO, Tokyo (JP); Satoshi MIZUKAMI, Tokyo (JP); Tomoto NAGAI, Tokyo (JP)

(73) Assignee: MITSUBISHI HEAVY INDUSTRIES, LTD., Tokyo (JP)

(21) Appl. No.: 15/543,046

(22) PCT Filed: Sep. 25, 2015
(86) PCT No.: PCT/JP2015/077152

§ 371 Date: Jul. 12, 2017

(30) Foreign Application Priority Data
Jan. 27, 2015 (JP) 2015-013140

(51) Int. Cl. F01D 5/08; F01D 5/22; F01D 11/00

(52) U.S. Cl. CPC F01D 5/081; F01D 11/006; F01D 5/225; F05D 2230/232; F05D 2220/32; F05D 2230/60; F05D 2260/20; F05D 2230/21

(57) ABSTRACT

A turbine blade disposed along a radial direction of a turbine includes: an airfoil portion positioned in a fluid flow passage of the turbine; and a shroud portion positioned on an inner side or an outer side of the airfoil portion in the radial direction, and having an opening with which an end portion of the airfoil portion is to be engaged. A clearance is formed between a wall surface forming the opening of the shroud portion and an outer peripheral surface of the end portion of the airfoil portion. The wall surface of the shroud portion and the outer peripheral surface of the airfoil portion are joined to each other. At least one of the shroud portion or the airfoil portion has a cooling hole formed thereon, the cooling hole having an opening into the clearance and being configured to supply the clearance with a cooling fluid.

### TECHNICAL FIELD

The present disclosure relates to a turbine blade, a turbine, and a method for producing a turbine blade.

### BACKGROUND ART

A known turbine for a turbine is obtained by joining casted components by welding.

For instance, Patent Document 1 discloses a turbine stator vane obtained by joining a casted blade portion and a casted shroud portion by welding. In this turbine stator vane, to reduce the restriction of thermal deformation of a shroud, the blade portion and the shroud portion are welded partially in the thickness direction from the cooling surface side of the shroud, and clearance (non-welded portion) is left between the blade portion and the shroud portion in the vicinity of the high-temperature fluid surface of the shroud.

### CITATION LIST

### Patent Literature

Patent Document 1: JPS60-57705U (Utility Model)

### SUMMARY

### Problems to be Solved

If the blade portion and the shroud portion are welded partially in the thickness direction of the shroud and clearance is formed like the turbine stator vane described in Patent Document 1, the clearance permits the blade portion and the shroud portion to deform slightly when an external force or heat is applied to the turbine blade. Thus, stress is reduced compared to a case in which the blade portion and the shroud portion are welded entirely without leaving the clearance. On the other hand, if the clearance is formed by partial welding of the blade portion and the shroud portion between a flow passage of combustion gas and the welded section, high-temperature combustion gas enters the clearance to increase the temperature of the welded section, raising the risk of thermal damage to the welded section, which may shorten the lifetime of the turbine blade.

Thus, it is desirable to suppress a temperature increase of a welded section of a turbine blade.

In view of the above, an object of at least one embodiment of the present invention is to provide a turbine blade whereby it is possible to suppress a temperature increase of a welded section.

### Solution to the Problems

(1) A turbine blade disposed along a radial direction of a turbine according to at least one embodiment of the present invention comprises: an airfoil portion positioned in a fluid flow passage of the turbine; and a shroud portion positioned on an inner side or an outer side of the airfoil portion in the radial direction, and having an opening with which an end portion of the airfoil portion is to be engaged. A clearance is formed between a wall surface forming the opening of the shroud portion and an outer peripheral surface of the end portion of the airfoil portion. The wall surface of the shroud portion and the outer peripheral surface of the airfoil portion are joined to each other via a welded section on an opposite side to the flow fluid passage across the clearance. At least one of the shroud portion or the airfoil portion has a cooling hole formed thereon, the cooling hole having an opening into the clearance and being configured to supply the clearance with a cooling fluid.

With the above configuration (1), the clearance formed between the shroud portion and the airfoil portion permits slight deformation of the airfoil portion and the shroud portion, and thereby it is possible to suppress stress concentration to the welded section during operation of the turbine. The cooling hole formed on at least one of the shroud portion or the airfoil portion supplies the clearance formed between the shroud portion and the airfoil portion with the cooling fluid, and thus it is possible to prevent high-temperature fluid flowing through the fluid flow passage from entering the clearance. Accordingly, it is possible to suppress a temperature increase of the welded section at the opposite side to the fluid flow passage across the clearance, and to increase the lifetime of the turbine blade.

(2) In some embodiments, in the above configuration (1), the shroud portion includes an inner shroud and an outer shroud which are disposed on the inner side and the outer side of the airfoil portion in the radial direction, respectively, and each of which has the opening. The clearance is formed between the wall surface of each of the inner shroud and the outer shroud and the outer peripheral surface of each end portion of the airfoil portion. The wall surface of each of the inner shroud and the outer shroud and the outer peripheral surface of each end portion of the airfoil portion are joined to each other via the welded section on the opposite side to the fluid flow passage across the clearance.

With the above configuration (2), the cooling fluid is supplied from the cooling hole to the clearance formed between the inner shroud and the airfoil portion and between the outer shroud portion and the airfoil portion, and thus it is possible to prevent high-temperature fluid from entering the clearance more effectively. Accordingly, it is possible to suppress a temperature increase of each welded section at the opposite side to the fluid flow passage across each clearance, and to increase the lifetime of the turbine blade even further.

(3) In some embodiments, in the above configuration (1) or (2), the airfoil portion has a hollow portion configured such that the cooling fluid flows through the hollow portion. The cooling hole includes a first cooling hole configured such that the hollow portion of the airfoil portion and the clearance are in communication through the first cooling hole.

With the above configuration (3), the cooling fluid flowing through the hollow portion can be supplied to the clearance via the first cooling hole configured to bring the hollow portion of the airfoil portion and the clearance into communication, and thus it is possible to prevent high-temperature fluid from entering the clearance.

(4) In some embodiments, in any one of the above configurations (1) to (3), the turbine blade comprises a shield plate disposed inside the shroud portion, and forming a cooling passage configured to let the cooling fluid flow through the cooling passage, together with an inner wall surface of the shroud portion. The cooling hole includes a second cooling hole configured such that the cooling passage inside the shroud portion and the clearance are in communication through the second cooling hole.

With the above configuration (4), the cooling fluid flowing through the cooling passage formed by the inner wall surface of the shroud portion and the shield plate can be supplied to the clearance via the second cooling hole configured to bring the clearance and the cooling passage into communication, and thus it is possible to prevent high-temperature fluid from entering the clearance.

(5) In some embodiments, in any one of the above configurations (1) to (4), the welded section includes a first welded section along an extending direction of the clearance.

(6) Furthermore, in some embodiments, in any one of the above configurations (1) to (5), the welded section includes a second welded section along a width direction of the clearance.

With the above configuration (5) or (6), with the first welded section and/or the second welded section, the airfoil portion and the shroud portion can be joined firmly.

(7) In some embodiments, in any one of the above configurations (1) to (6), the shroud portion has an injection hole formed thereon, the injection hole being disposed around the clearance so as to have an opening into the fluid flow passage and being configured to inject the cooling fluid. The injection hole is inclined with respect to the radial direction so as to be closer to the airfoil portion toward the fluid flow passage.

With the above configuration (7), the cooling fluid is injected from the injection hole disposed in the shroud portion around the clearance toward the airfoil portion, and thus it is possible to further suppress entry of the high-temperature fluid inside the fluid flow passage to the clearance. Accordingly, with the high-temperature fluid being prevented from entering the clearance, it is possible to suppress a temperature increase of the welded section and to suppress a temperature increase of the airfoil portion. Accordingly, it is possible to increase the lifetime of the turbine blade even more.

(8) In some embodiments, in any one of the above configurations (1) to (7), an edge of the opening facing the fluid flow passage of the shroud portion has a curved cross-sectional shape along an extending direction of the airfoil portion.

With the above configuration (8), the surface of the airfoil portion is less likely to be damaged when the end portion of the airfoil portion is fitted into the opening of the shroud portion during assembly of the turbine blade, even if the edge of the opening of the shroud portion makes contact with the airfoil portion, for the edge of the opening of the shroud portion has a curved smooth cross-sectional shape. Accordingly, it is possible to increase the lifetime of the turbine blade even more.

(9) A turbine according to at least one embodiment of the present invention comprises a rotor which comprises the turbine blade according to any one of the above (1) to (8).

With the above configuration (9), the clearance formed between the shroud portion and the airfoil portion permits slight deformation of the airfoil portion and the shroud portion, and thereby it is possible to suppress stress concentration to the welded section during operation of the turbine. The cooling hole formed on at least one of the shroud portion or the airfoil portion supplies the clearance formed between the shroud portion and the airfoil portion with the cooling fluid, and thus it is possible to prevent high-temperature fluid flowing through the fluid flow passage from entering the clearance. Accordingly, it is possible to suppress a temperature increase of the welded section at the opposite side to the fluid flow passage across the clearance, and to increase the lifetime of the turbine blade.

(10) A method of producing a turbine blade which comprises an airfoil portion disposed in a fluid flow passage of a turbine and a shroud portion having an opening with which an end portion of the airfoil portion is to be engaged, according to at least one embodiment of the present invention, comprises: a step of fitting the end portion of the airfoil portion into the opening of the shroud portion so that a cooling hole formed on at least one of the shroud portion or the airfoil portion has an opening into a clearance formed between a wall surface forming the opening of the shroud portion and an outer peripheral surface of the end portion of the airfoil portion; and a step of welding the wall surface of the shroud portion and the outer peripheral surface of the airfoil portion at an opposite side to the flow fluid passage across the cooling hole. The welding step includes forming a welded section in the clearance only on an opposite side to the fluid flow passage as seen from the cooling hole so that the clearance remains at least at an opening position of the cooling hole and at a side closer to the fluid flow passage than the opening position.

With a turbine blade produced by the above method (10), the clearance formed between the shroud portion and the airfoil portion permits slight deformation of the airfoil portion and the shroud portion, and thereby it is possible to suppress stress concentration to the welded section during operation of the turbine. The cooling hole formed on at least one of the shroud portion or the airfoil portion supplies the clearance formed between the shroud portion and the airfoil portion with the cooling fluid, and thus it is possible to prevent high-temperature fluid flowing through the combustion gas flow passage from entering the clearance. Accordingly, it is possible to suppress a temperature increase of the welded section at the opposite side to the fluid flow passage across the clearance, and to increase the lifetime of the turbine blade.

(11) In some embodiments, in the above configuration (10), the method further comprises a casting step of casting each of the airfoil portion and the shroud portion separately.

According to the above method (11), with each of the airfoil portion and the shroud portion casted individually, the casted products have a relatively simple structure compared to a case in which the airfoil portion and the shroud portion are casted integrally. Thus, it is possible to reduce casting defects and to improve the yield.

(12) In some embodiments, in the above configuration (10) or (11), the shroud portion includes an inner shroud and an outer shroud disposed on a first side and a second side of the airfoil portion, respectively, each of the inner shroud and the outer shroud having the opening. The fitting step includes fitting each end portion of the airfoil portion into the opening of each of the inner shroud and the outer shroud so that the cooling hole has an opening into the clearance formed between the wall surface forming the opening of each of the inner shroud and the outer shroud and the outer peripheral surface of each end portion of the airfoil portion. The welding step includes welding the wall surface of each of the inner shroud and the outer shroud and the outer peripheral surface of each end portion of the airfoil portion on the opposite side to the fluid flow passage across the cooling hole.

With a turbine blade produced by the above method (12), the cooling fluid is supplied from the cooling hole to the clearance formed between the inner shroud and the airfoil portion and the clearance between the outer shroud portion and the airfoil portion, and thus it is possible to prevent high-temperature fluid from entering the clearance more effectively. Accordingly, it is possible to suppress a temperature increase of each welded section at the opposite side to the fluid flow passage across each clearance, and to increase the lifetime of the turbine blade even further.

### Advantageous Effects

According to at least one embodiment of the present invention, provided is a turbine blade whereby it is possible to suppress a temperature increase of a welded section.

### BRIEF DESCRIPTION OF DRAWINGS

FIG. 1 is a schematic configuration diagram of a gas turbine provided with a turbine according to an embodiment.

FIG. 2 is a perspective view of stator vanes including a turbine blade according to an embodiment.

FIG. 3 is a perspective view of a turbine blade according to an embodiment.

FIG. 4 is a cross-sectional view taken along line C-C in FIG. 3.

FIG. 5 is an enlarged cross-sectional view of a turbine blade according to an embodiment, corresponding to section A shown in FIG. 4.

FIG. 6 is an enlarged cross-sectional view of a turbine blade according to an embodiment, corresponding to section A shown in FIG. 4.

FIG. 7 is an enlarged cross-sectional view of a turbine blade according to an embodiment, corresponding to section A shown in FIG. 4.

FIG. 8 is an enlarged cross-sectional view of a turbine blade according to an embodiment, corresponding to section A shown in FIG. 4.

FIG. 9 is an enlarged cross-sectional view of a turbine blade according to an embodiment, corresponding to section A shown in FIG. 4.

FIG. 10 is an enlarged cross-sectional view of a turbine blade according to an embodiment, corresponding to section A shown in FIG. 4.

FIG. 11 is an enlarged cross-sectional view of a turbine blade according to an embodiment, corresponding to section A and section B shown in FIG. 4.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not intended to limit the scope of the present invention.

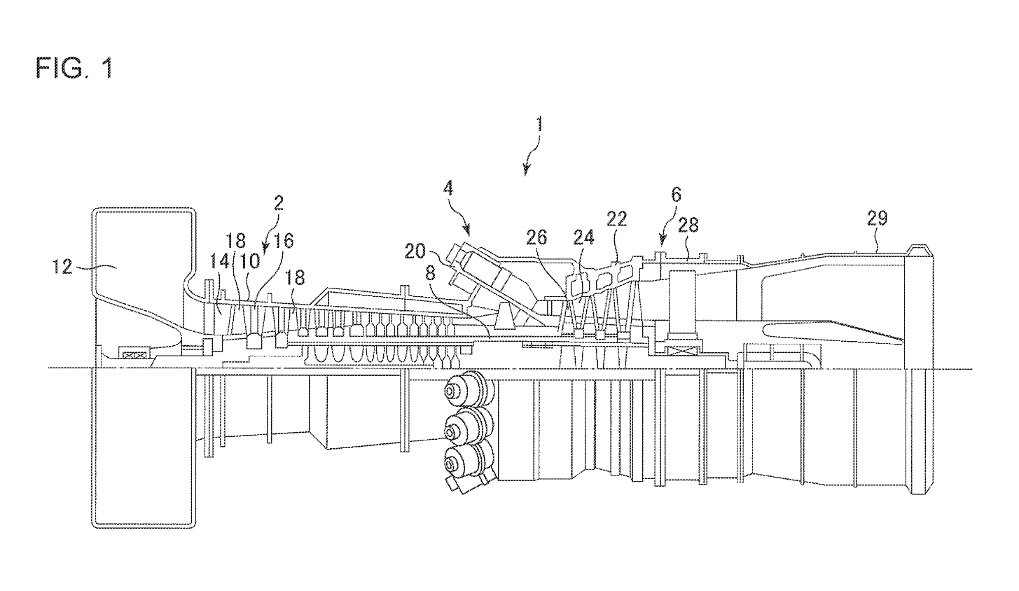

First, with reference to FIG. 1, a gas turbine, which is an example of application of a turbine blade and a turbine according to the present invention will be described. FIG. 1 is a schematic configuration diagram of a gas turbine provided with a turbine according to an embodiment.

As depicted in FIG. 1, the gas turbine 1 according to an embodiment includes a compressor 2 for producing compressed air, a combustor 4 for producing combustion gas from the compressed air and fuel, and a turbine 6 configured to be rotary-driven by combustion gas. In the case of the gas turbine 1 for power generation, a generator (not illustrated) is connected to the turbine 6, so that rotational energy of the turbine 6 generates electric power.

The configuration example of components in the gas turbine 1 will be described in detail.

The compressor 2 includes a compressor casing 10, an air inlet 12 for sucking in air, disposed on an inlet side of the compressor casing 10, a rotor 8 disposed so as to penetrate through both of the compressor casing 10 and a turbine casing 22 described below, and a variety of blades disposed in the compressor casing 10. The variety of blades includes an inlet guide vane 14 disposed adjacent to the air inlet 12, a plurality of stator vanes 16 fixed to the compressor casing 10, and a plurality of rotor blades 18 implanted on the rotor 8 so as to be arranged alternately with the stator vanes 16. The compressor 2 may include other constituent elements not illustrated in the drawings, such as an extraction chamber. In the above compressor 2, the air introduced from the air inlet 12 flows through the plurality of stator vanes 16 and the plurality of rotor blades 18 to be compressed to turn into compressed air having a high temperature and a high pressure. The compressed air having a high temperature and a high pressure is sent to the combustor 4 of a latter stage from the compressor 2.

The combustor 4 is disposed in a casing 20. As illustrated in FIG. 1, a plurality of combustors 4 may be disposed in annular shape centered at the rotor 8 inside the casing 20. The combustor 4 is supplied with fuel and the compressed air produced in the compressor 2, and combusts the fuel to produce combustion gas that serves as a working fluid of the turbine 6. The combustion gas is sent to the turbine 6 of a latter stage from the combustor 4.

The turbine 6 includes a turbine casing 22 and a variety of blades disposed inside the turbine casing 22. The variety of blades includes a plurality of stator vanes 24 fixed to the turbine casing 22 and a plurality of rotor blades 26 implanted on the rotor 8 so as to be arranged alternately with the stator vanes 24. The plurality of stator vanes 24 and the plurality of rotor blades 26 include a turbine blade 100 described below in detail. The stator vanes 5 of each stage include a plurality of turbine stator vane bodies (airfoil portions 30) arranged at a regular interval in an annular shape in the circumferential direction of the rotor 8, fixed to the side of the turbine casing 22 in a radial fashion toward the rotor 8. Furthermore, the rotor blades 26 of each stage include a plurality of turbine rotor blade bodies (airfoil portions 30) arranged at a regular interval in an annular shape in the circumferential direction of the rotor 8, fixed to the side of the rotor 8 in a radial fashion toward the turbine casing 22.

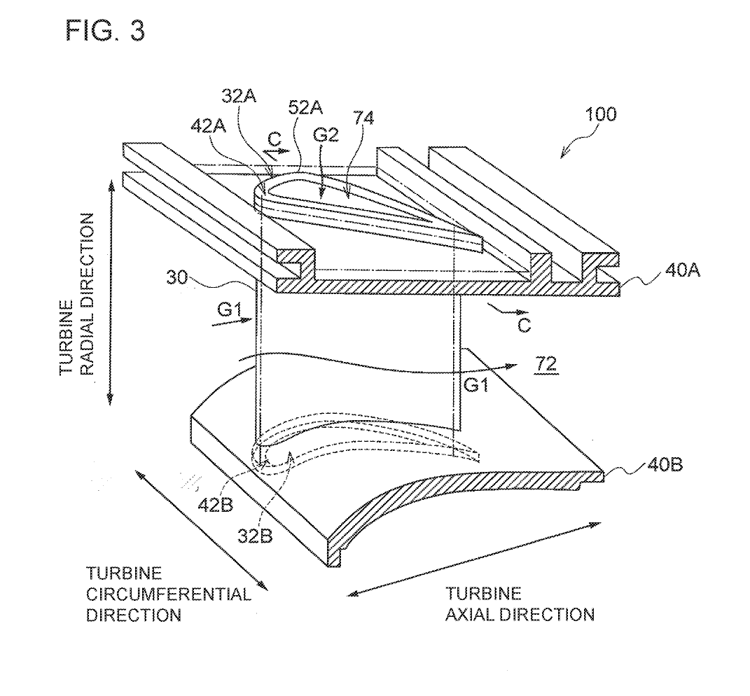

Furthermore, the turbine 6 includes a bypass flow passage (not shown) for supplying air inside the compressor 2 from the compressor 2 bypassing the combustor 4. Air supplied to the turbine 6 through the bypass flow passage flows through the inside of each of the turbine stator vane bodies and the turbine rotor blade bodies as a cooling fluid G2 (see FIG. 3).

The turbine 6 may include other constituent elements, such as outlet guide vanes and the like. In the turbine 6, a combustion gas G1 (see FIG. 3) flows through the plurality of stator vanes 24 and the plurality of rotor blades 26, and thereby the rotor 8 is rotary driven. In this way, the generator connected to the rotor 8 is driven.

An exhaust chamber 29 is connected to the downstream side of the turbine casing 22 via an exhaust casing 28. The exhaust gas having driven the turbine 6 is discharged outside via the exhaust casing 28 and the exhaust chamber 29.

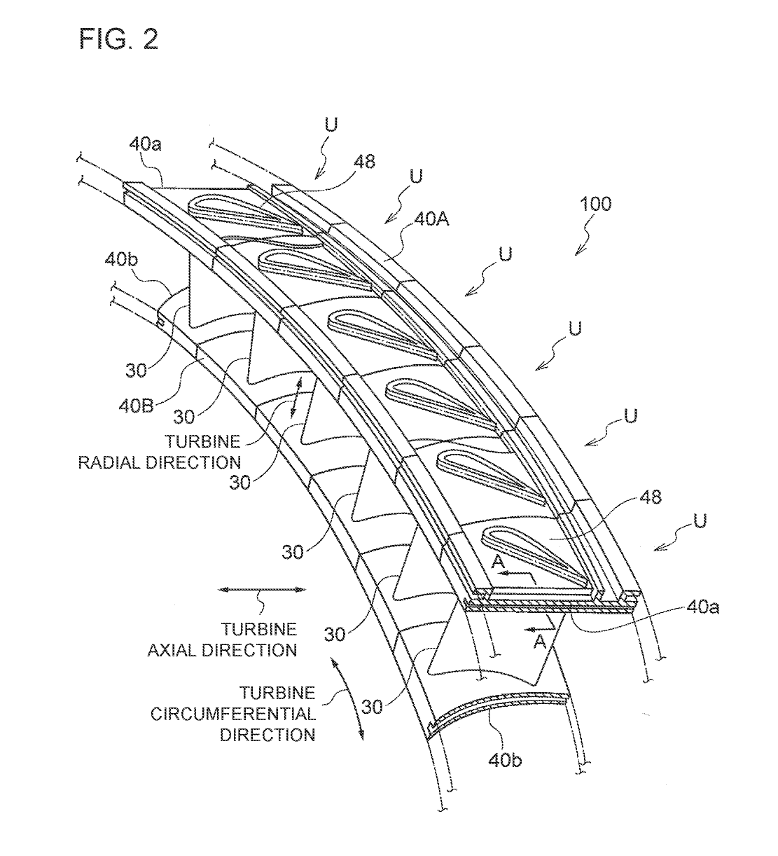

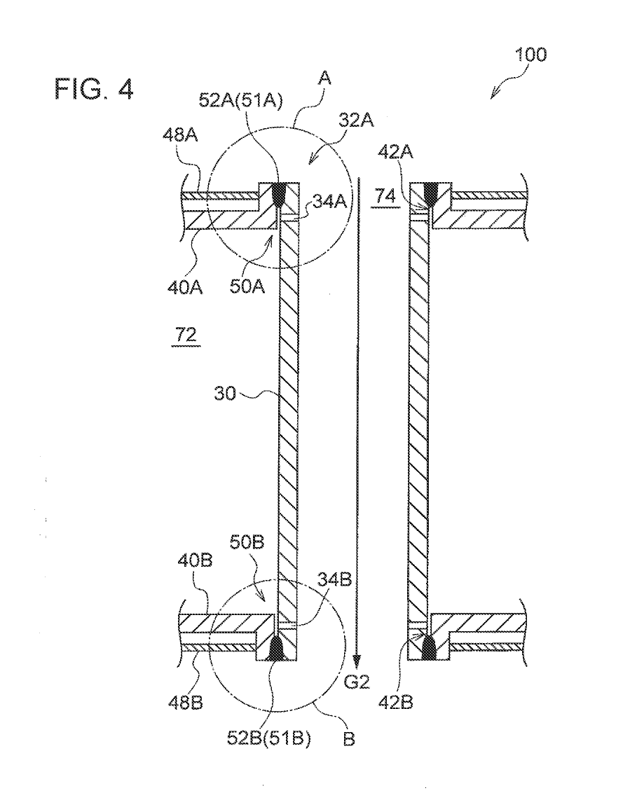

Next, as a turbine blade 100 according to an embodiment, the configuration of the turbine blade applied to the stator vane 24 will be described. FIG. 2 is a perspective view of a stator vane including a turbine blade according to an embodiment. FIG. 3 is a perspective view of a turbine blade according to an embodiment. FIG. 4 is a cross-sectional view taken along line C-C in FIG. 3. In another embodiment, the turbine blade 100 may be applied to the rotor blades 26.

As depicted in FIGS. 2 and 3, the turbine blade 100 is disposed along the radial direction of the turbine 6, and includes an airfoil portion 30 disposed inside a fluid flow passage 72 through which the combustion gas G1 from the combustor 4 flows, and a shroud portion 40 disposed on the outer side or inner side of the airfoil portion 30 in the radial direction of the turbine 6. The shroud portion 40 includes an outer shroud 40A disposed on the outer side of the airfoil portion 30 in the radial direction of the turbine 6, and an inner shroud 40B disposed on the inner side of the airfoil portion 30.

As shown in FIG. 2, one stage of stator vanes 24 may include a plurality of unit structures U coupled in the circumferential direction of the turbine 6, each unit structure U including a single airfoil portion 30 and a pair of outer shrouds (40A, 40B) provided corresponding to the single airfoil portion 30.

Each shroud portion 40 (40A, 40B) of each unit structure U has a coupling portion 40a, and may be connectable at the coupling portion 40a via the coupling portion 40a of the adjacent unit structure U.

The fluid flow passage 72 carrying the combustion gas G1 is formed in a range where the airfoil portions 30 are arranged, surrounded by the outer shroud 40A and the inner shroud 40B being partition walls.

As shown in FIGS. 3 and 4, the shroud portion 40 (40A, 40B) has an opening 42 (42A, 42B), and an end portion 32 (32A, 32B) of the airfoil portion 30 is engaged with the opening 42 (42A, 42B). The airfoil portion 30 and the shroud portion 40 (40A, 40B) are joined to each other via a welded section 51A.

Furthermore, the airfoil portion 30 has a hollow portion 74 formed to penetrate through along the radial direction of the turbine 6. A cooling fluid G2 from the compressor 2 flows through the hollow portion 74. The cooling fluid G2 cools the airfoil portion 30, and thereby the airfoil portion 30 is protected from damage due to high-temperature fluid (combustion gas) flowing through the fluid flow passage 72. The airfoil portion 30 may have a plurality of holes (not depicted) formed thereon, through which the hollow portion 74 and the fluid flow passage 72 communicate with each other, so that the cooling fluid G2 from the hollow portion 74 passes through the holes to cool the airfoil portion 30 even more effectively.

In some embodiments, the turbine blade 100 may include only one of the outer shroud 40A or the inner shroud 40B having the above configuration.

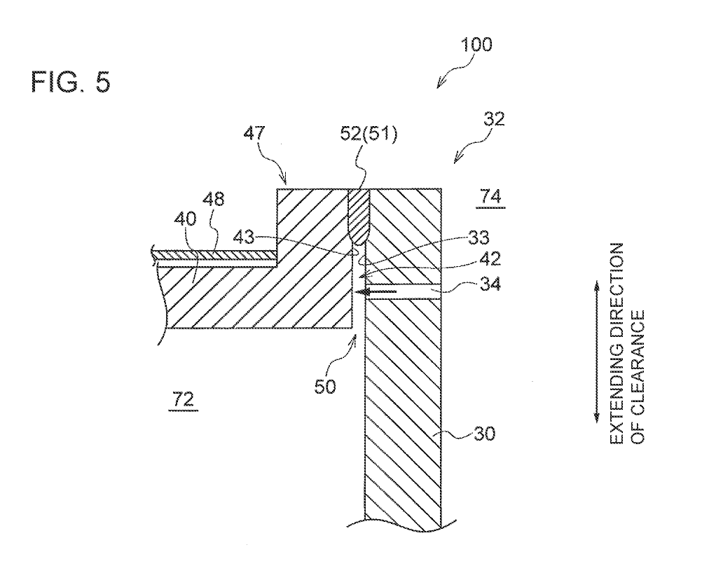

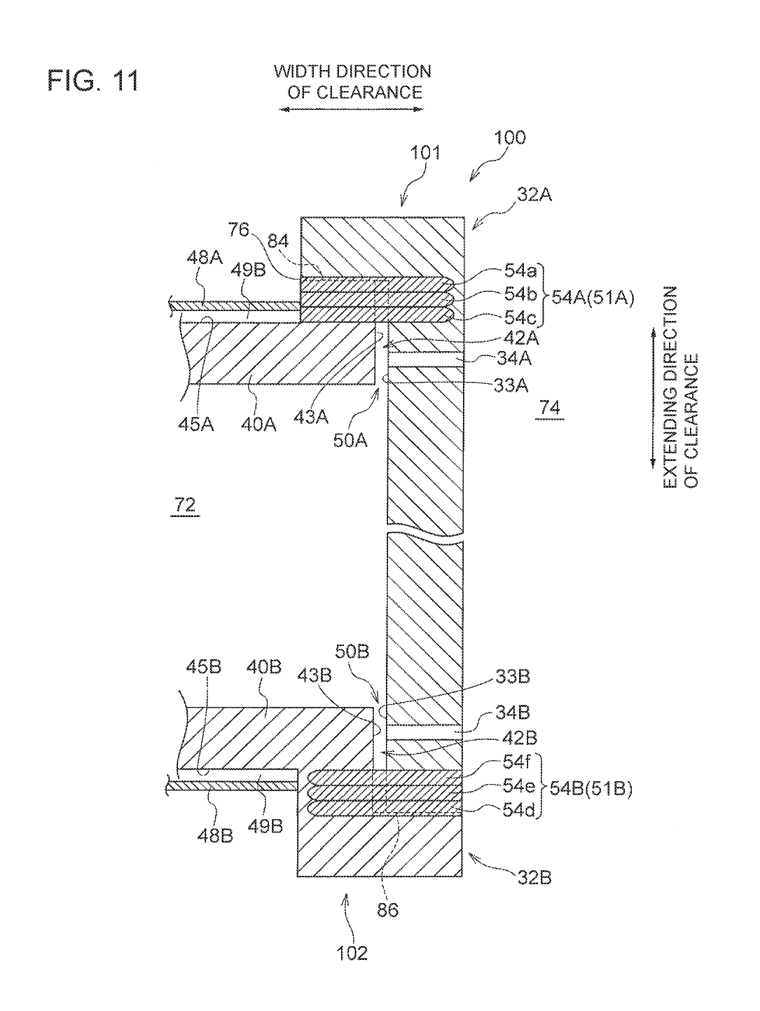

FIGS. 5 to 11 are each a diagram showing a turbine blade according to an embodiment. FIGS. 5 to 10 are each an enlarged cross-sectional view of a section corresponding to section A in FIG. 4, and FIG. 11 is an enlarged cross-sectional view of a portion corresponding to section A and section B shown in FIG. 4. While section A in FIG. 4 is a section near the welded section 51A at which the airfoil portion 30 and the outer shroud 40A are joined to each other, section B near the welded section 51B at which the airfoil portion 30 and the inner shroud 40B are joined to each other may have the same configuration as section A shown in FIGS. 5 to 10. In the following description, “outer shroud 40A” is described as “shroud portion 40”, and the reference sign “A” for indicating elements of the outer shroud is omitted.

As shown in FIGS. 5 to 11, in the turbine blade 100, clearance 50 is formed between a wall surface 43 forming the opening 42 of the shroud portion 40 and the outer peripheral surface 33 of the end portion 32 of the airfoil portion 30. Furthermore, the wall surface 43 of the shroud portion 40 and the outer peripheral surface 33 of the end portion 32 of the airfoil portion 30 are joined to each other via the welded section 51, at the opposite side to the fluid flow passage 72 across the clearance 50.

The clearance 50 formed between the shroud portion 40 and the airfoil portion 30 permits slight deformation of the airfoil portion 30 and the shroud portion 40, and thereby it is possible to suppress stress concentration to the welded section 51 during operation of the turbine 6.

In the turbine blade 100 according to an embodiment shown in FIGS. 5 to 8 and 10, the welded section 51 includes a first welded section 52 along the extending direction of the clearance 50 (in FIGS. 5 to 8, the extending direction of the airfoil portion 30).

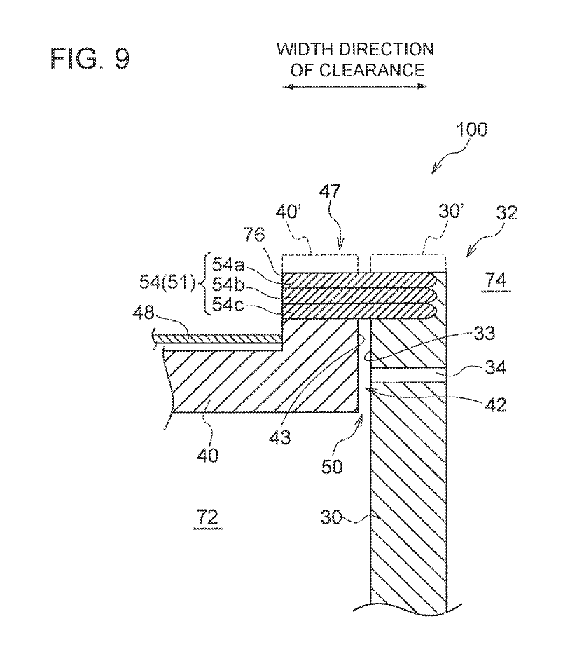

Further, in the turbine blade 100 according to an embodiment shown in FIGS. 9 to 11, the welded section 51 includes a second welded section 54 (54a to 54c) along the width direction of the clearance 50.

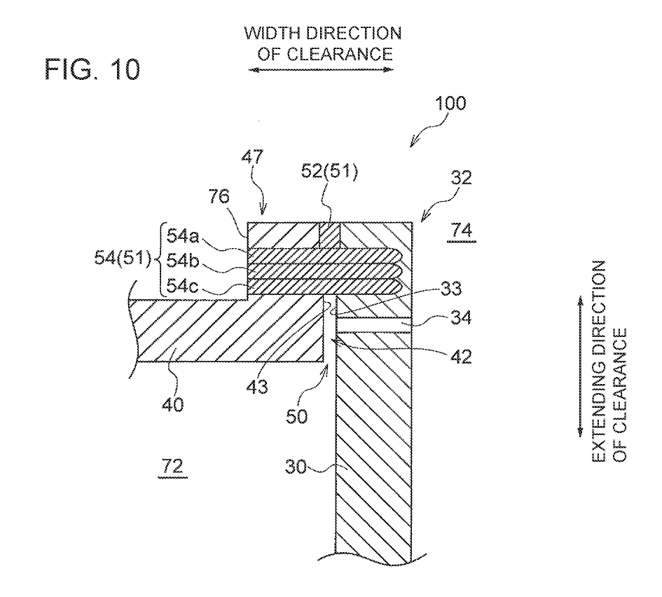

Accordingly, with the first welded section 52 or the second welded section 54 (54a to 54c), the airfoil portion 30 and the shroud portion 40 of the turbine blade 100 can be joined firmly. Furthermore, as depicted in FIG. 10, by providing both of the first welded section 52 along the extending direction of the clearance 50 and the second welded section 54 (54a to 54c) along the width direction of the clearance 50, the airfoil portion 30 and the shroud portion 40 of the turbine blade 100 can be joined firmly.

In the turbine blade 100, at least one of the shroud portion 40 or the airfoil portion 30 has a cooling hole (34, 44) formed to have an opening into the clearance 50 and configured to supply the cooling fluid G2 to the clearance 50.

The cooling hole (34, 44) supplies the clearance 50 formed between the shroud portion 40 and the airfoil portion 30 with the cooling fluid G2, and thus it is possible to prevent high-temperature fluid (combustion gas G1) flowing through the fluid flow passage 72 from entering the clearance 50. Accordingly, it is possible to suppress a temperature increase of the welded section 51 (52, 54) at the opposite side to the fluid flow passage 72 across the clearance 50, and to increase the lifetime of the turbine blade 100.

In the turbine blade 100 shown in FIGS. 5 to 11, the cooling hole includes a first cooling hole 34 disposed on the airfoil portion 30. The first cooling hole 34 is disposed so as to bring the hollow portion 74 of the airfoil portion 30 and the clearance 50 into communication. The cooling fluid G2 flowing through the hollow portion 74 can be supplied to the clearance 50 via the first cooling hole 34 having the above configuration, and thus it is possible to prevent high-temperature fluid (combustion gas G1) flowing through the fluid flow passage 72 from entering the clearance 50.

A plurality of such first cooling holes 34 may be provided for the airfoil portion 30 in the circumferential direction, or in the radial direction of the turbine 6. By providing a plurality of first cooling holes 34, it is possible to prevent high-temperature fluid (combustion gas G1) flowing through the fluid flow passage 72 from entering the clearance 50 even more effectively.

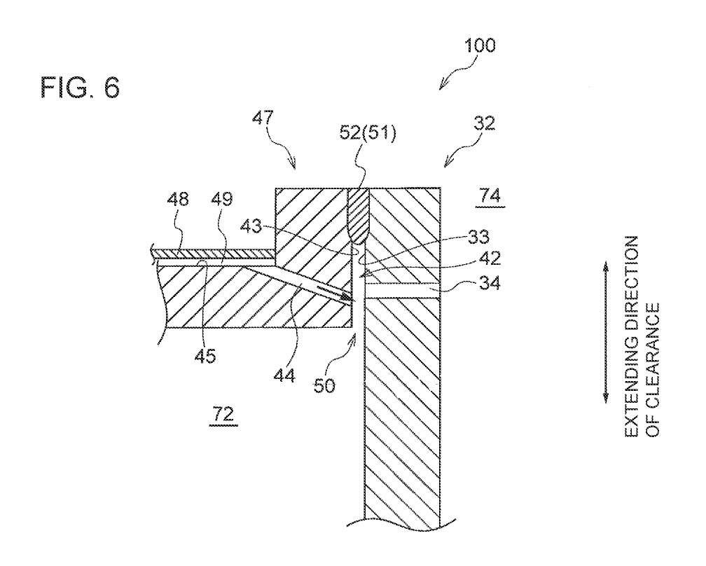

In the turbine blade 100 shown in FIG. 6, the cooling hole includes a second cooling hole 44 disposed on the shroud portion 40. This turbine blade 100 includes a shield plate 48 disposed inside the shroud portion 40, and a cooling passage 49 is formed between the inner wall surface 45 of the shroud portion 40 and the shield plate 48. The cooling fluid G2 from the compressor 2 flows through the cooling passage 49. The second cooling hole 44 is disposed so as to bring the cooling passage 49 inside the airfoil portion 40 and the clearance 50 into communication. The cooling fluid flowing through the cooling passage 49 can be supplied to the clearance 50 via the second cooling hole 44 having the above configuration, and thus it is possible to prevent high-temperature fluid (combustion gas G1) flowing through the fluid flow passage 72 from entering the clearance 50.

A plurality of such second cooling holes 44 may be provided for the shroud portion 40 in the circumferential direction, or in the radial direction of the turbine 6. With a plurality of second cooling holes 44, it is possible to prevent high-temperature fluid (combustion gas G1) flowing through the fluid flow passage 72 from entering the clearance 50 even more effectively.

While the first cooling hole 34 is provided for each turbine blade 100 in the embodiments shown in FIGS. 5 to 11, only the second cooling hole 44 may be provided in another embodiment, without providing the first cooling hole 34. Furthermore, as shown in FIG. 6, the turbine blade 100 may be provided with both of the first cooling hole 34 and the second cooling hole 44.

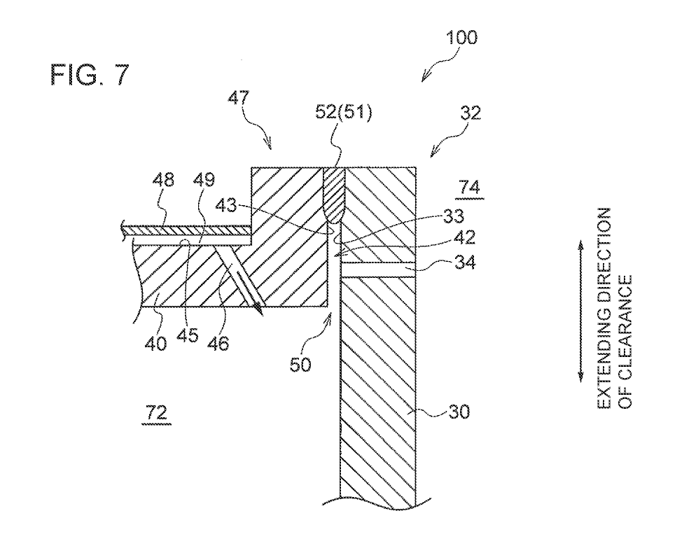

In the turbine blade 100, the shroud portion 40 may have an injection hole 46 separately provided from the cooling hole (second cooling hole 44). In the embodiment depicted in FIG. 7, the shroud portion 40 has an injection hole 46 formed to have an opening into the fluid flow passage 72, around the clearance 50. Similarly to the embodiment depicted in FIG. 6, this turbine blade 100 includes a shield plate 48 disposed inside the shroud portion 40, and a cooling passage 49 is formed through the inner wall surface 45 of the shroud portion 40 and the shield plate 48. The cooling fluid G2 from the compressor 2 flows through the cooling passage 49. The injection hole 46 is formed inclined with respect to the radial direction of the turbine 6 so as to be closer to the airfoil portion 30 toward the fluid flow passage 72 from the cooling passage 49, and configured to inject a cooling fluid that flows through the cooling passage 49 inside the shroud portion 40.

In this turbine blade 100, the cooling fluid is injected from the injection hole 46 disposed in the shroud portion 40 toward the airfoil portion 30, and thus it is possible to further suppress entry of the high-temperature fluid inside the fluid flow passage 72 to the clearance 50.

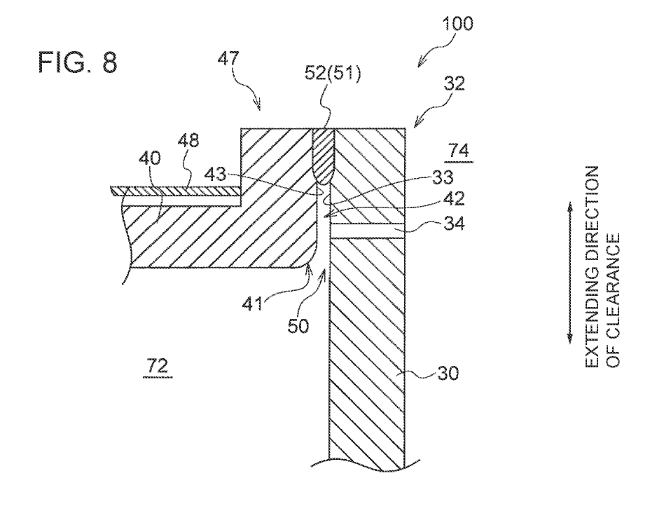

Further, as depicted in FIG. 8, in the turbine blade 100, of the shroud portion 40, the edge 41 of the opening 42 facing the fluid flow passage 72 may have a curved cross-sectional shape along the extending direction of the airfoil portion 30.

With the edge 41 of the shroud portion 40 having the above described curved shape, the surface of the airfoil portion 30 is less likely to get damaged when the end portion 32 of the airfoil portion 30 is fitted into the opening 42 of the shroud portion 40 during assembly of the turbine blade 100, even if the edge 41 of the opening 42 of the shroud portion 40 makes contact with the airfoil portion 30. Accordingly, it is possible to increase the lifetime of the turbine blade 100 even more.

Next, a method of producing the turbine blade 100 described above with reference to FIGS. 2 to 11 will now be described.

A method of producing the turbine blade 100 according to an embodiment includes a fitting step and a welding step described below.

The end portion 32 of the airfoil portion 30 is fitted into the opening 42 of the shroud portion 40. At this time, the clearance 50 is formed between the wall surface 43 forming the opening 42 of the shroud portion 40 and the outer peripheral surface 33 of the end portion 32 of the airfoil portion 30, and a cooling hole (the first cooling hole 34 or the second cooling hole 44) formed on at least one of the shroud portion 40 or the airfoil portion 30 has an opening into the clearance 50 (fitting step).

Next, on the opposite side to the fluid flow passage 72 across the cooling hole (the first cooling hole 34 or the second cooling hole 44), the wall surface 43 of the shroud portion 40 and the outer peripheral surface 33 of the airfoil portion 30 are welded (welding step). In the welding step, the welded section 51 is formed on the clearance 50 on the opposite side to the fluid flow passage 72 as seen from the cooling hole (the first cooling hole 34 or the second cooling hole 44) so that the clearance 50 remains at the opening position of the cooling hole (the first cooling hole 34 or the second cooling hole 44) and at the side closer to the fluid flow passage 72 than the opening position.

The first welded section 52 along the extending direction of the clearance 50 shown in FIGS. 5 to 8 and 10 is formed by welding the wall surface 43 of the opening 42 formed by a flange 47 of the shroud portion 40 and the outer peripheral surface 33 of the end portion 32 of the airfoil portion 30 from the opposite side to the fluid flow passage 72, forming an I-shape groove at which the two surfaces are joined. Furthermore, welding is performed not by full penetration welding but by incomplete penetration welding, so that a slit (clearance 50) is formed between the wall surface 43 of the opening 42 of the shroud portion 40 and the outer peripheral surface 33 of the end portion 32 of the airfoil portion 30.

Various welding methods can be employed, such as laser welding, electronic beam welding, plasma welding, TIG welding, etc.

The depth of the slit to be formed (the length of the clearance 50 in the extending direction) is determined depending on the welding penetration depth, and the welding penetration depth can be controlled by welding conditions.

Further, it is possible to adjust the flow rate of cooling gas by adjusting the width of the slit (clearance 50) formed during welding. Specifically, it is possible to prevent the combustion gas G1 from entering the clearance 50 by making the cooling fluid G2 flow through the cooling hole (the first cooling hole 34 or the second cooling hole 44) at such a pressure that the combustion gas G1 does not enter the clearance 50. Accordingly, it is possible to maintain the efficiency of the turbine 6 appropriately by appropriately adjusting the flow rate of the cooling fluid G2 flowing through the cooling hole (the first cooling hole 34 or the second cooling hole 44).

The second welded section 54 (54a to 54c) along the width direction of the clearance 50 shown in FIGS. 9 to 11 is formed by joining the wall surface 43 of the opening 42 of the shroud portion 40 and the outer peripheral surface 33 of the end portion 32 of the airfoil portion 30 and performing penetration welding from a side. Welding can be performed from the side of a wall surface 76 opposite from the wall surface 43 forming the clearance 50, or from the inner peripheral side of the airfoil portion 30, of the wall surfaces of the shroud portion 40.

If welding is performed from a side, it is possible to increase the penetration depth by increasing the layer of welding, and thus a desired penetration depth can be obtained relatively easily. Thus, the slit (clearance 50) is formed relatively easily between the wall surface 43 of the opening 42 of the shroud portion 40 and the outer peripheral surface 33 of the end portion 32 of the airfoil portion 30. In FIGS. 9 to 11, the second welded section 54 is formed by three layers indicated by 54a to 54c.

Various welding methods can be employed, such as laser welding, electronic beam welding, etc.

Further, in the turbine blade 100 depicted in FIG. 11, at both end portions (32A, 32B) of the airfoil portion 30, one of the airfoil portion 30 or the shroud portion 40 has a flange, and the other has a contact surface that makes contact with the flange. In an example depicted in FIG. 11, at the end portion 32A of the airfoil portion 30 that is adjacent to the outer shroud 40A, the airfoil portion 30 has a flange 101, and the outer shroud 40A has a contact surface 84 that makes contact with the flange 101. Furthermore, at the end portion 32B of the airfoil portion 30 that is adjacent to the inner shroud 40B, the inner shroud 40B has a flange 102, and the airfoil portion 30 has a contact surface 86 that makes contact with the flange 102.

Accordingly, with a flange (101, 102) of one of the airfoil portion 30 or the shroud portion 40 making contact with a contact surface (84, 86) of the other one, it is possible to determine the position in the radial direction of the turbine 6 easily during welding.

In this case, the second welded section (54a, 54d) is formed by welding to join the butting surfaces of the flange (101, 102) of one of the airfoil portion 30 or the shroud portion 40 and the contact surface (84, 86) of the other, and then the layer of welding (the second welded section (54a, 54c, 54e, 54f) is formed so as to obtain a predetermined welding depth, which makes it possible to form the second welded section 54 of a desired length easily, and to obtain a slit of a desired length (clearance 50).

When the second welded section 54 is formed by joining the wall surface 43 of the opening 42 of the shroud portion 40 and the outer peripheral surface 33 of the end portion 32 of the airfoil portion 30 and performing penetration welding from a side, a part of the shroud portion 40 or the airfoil portion 30 may remain after welding depending on the welding conditions. In FIG. 9, such a remaining portion of the airfoil portion 30 and the shroud portion is shown as a remaining portion (30′, 40′). If such a remaining portion (30′, 40′) is remaining, a slit (clearance) is formed on both sides across the section joined at the welded section 51, and the strength of the welded section 51 decreases. Thus, if the remaining portion (30′, 40′) is formed by welding, the remaining portion (30′, 40′) may be removed by grinding or the like, to prevent strength reduction.

A method of producing the turbine blade 100 according to some embodiments further includes a casting step of casting each of the airfoil portion 30 and the shroud portion 40 (outer shroud 40A and/or inner shroud 40B). Then, by using the airfoil portion 30 and the shroud portion 40 casted in the casting step, the above described fitting step and welding step are performed to produce the turbine blade 100.

As described above, with each of the airfoil portion 30 and the shroud 40 casted individually, the casted products have a relatively simple structure compared to a case in which the airfoil portion 30 and the shroud portion 40 are casted integrally. Thus, it is possible to reduce casting defects and to improve the yield.

While various casting methods can be employed without particular limitation, precision casting suitable for making a precise casted product may be employed. For instance, lost-wax process can be used to produce an airfoil portion 30 and a shroud portion 40 having a complicated structure.

Embodiments of the present invention were described in detail above, but the present invention is not limited thereto, and various amendments and modifications may be implemented.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### DESCRIPTION OF REFERENCE NUMERAL

1 Gas turbine
2 Compressor
4 Combustor
5 Stator vane
6 Turbine
8 Rotor
10 Compressor casing
12 Air inlet
14 Inlet guide vane
16 Stator vane
18 Rotor blade
20 Casing
22 Turbine casing
24 Stator vane
26 Rotor blade
28 Exhaust casing
29 Exhaust chamber
30 Airfoil portion
32 End portion
33 Outer peripheral surface
34 First cooling hole
40 Shroud portion
40A Outer shroud
40B Inner shroud
40a Coupling portion
41 Edge
42 Opening
43 Wall surface
44 Second cooling hole
45 Inner wall surface
46 Injection hole
47 Flange
48 Shield plate
49 Cooling passage
50 Clearance
51 Welded section
52 First welded section
54 Second welded section
72 Fluid flow passage
74 Hollow portion
76 Wall surface
84 Contact surface
86 Contact surface
100 Turbine blade
101 Flange
102 Flange
U Unit structure

1-12. (canceled)

13. A turbine blade disposed along a radial direction of a turbine, comprising:
an airfoil portion positioned in a fluid flow passage of the turbine; and
a shroud portion positioned on an inner side or an outer side of the airfoil portion in the radial direction, and having an opening with which an end portion of the airfoil portion is to be engaged,
wherein a clearance is formed between a wall surface forming the opening of the shroud portion and an outer peripheral surface of the end portion of the airfoil portion,
wherein the wall surface of the shroud portion and the outer peripheral surface of the airfoil portion are joined to each other via a welded section on an opposite side to the flow fluid passage across the clearance, and
wherein at least one of the shroud portion or the airfoil portion has a cooling hole formed thereon, the cooling hole having an opening into the clearance and being configured to supply the clearance with a cooling fluid.

14. The turbine blade according to claim 13,
wherein the shroud portion includes an inner shroud and an outer shroud which are disposed on the inner side and the outer side of the airfoil portion in the radial direction, respectively, and each of which has the opening,
wherein the clearance is formed between the wall surface of each of the inner shroud and the outer shroud and the outer peripheral surface of each end portion of the airfoil portion, and
wherein the wall surface of each of the inner shroud and the outer shroud and the outer peripheral surface of each end portion of the airfoil portion are joined to each other via the welded section on the opposite side to the fluid flow passage across the clearance.

15. The turbine blade according to claim 13,
wherein the airfoil portion has a hollow portion configured such that the cooling fluid flows through the hollow portion, and
wherein the cooling hole includes a first cooling hole configured such that the hollow portion of the airfoil portion and the clearance are in communication through the first cooling hole.

16. The turbine blade according to claim 13, further comprising a shield plate disposed inside the shroud portion, and forming a cooling passage configured to let the cooling fluid flow through the cooling passage, together with an inner wall surface of the shroud portion,
wherein the cooling hole includes a second cooling hole configured such that the cooling passage inside the shroud portion and the clearance are in communication through the second cooling hole.

17. The turbine blade according to claim 13,
wherein the welded section includes a first welded section along an extending direction of the clearance.

18. The turbine blade according to claim 13,
wherein the welded section includes a second welded section along a width direction of the clearance.

19. The turbine blade according to claim 13,
wherein the shroud portion has an injection hole formed thereon, the injection hole being disposed around the clearance so as to have an opening into the fluid flow passage and being configured to inject the cooling fluid, and
wherein the injection hole is inclined with respect to the radial direction so as to be closer to the airfoil portion toward the fluid flow passage.

20. The turbine blade according to claim 13,
wherein an edge of the opening facing the fluid flow passage of the shroud portion has a curved cross-sectional shape along an extending direction of the airfoil portion.

21. The turbine blade according to claim 13,
wherein the cooling hole has an opening into the clearance for permitting deformation of the shroud portion and the airfoil portion, the clearance being formed between the wall surface of the shroud portion and the outer peripheral surface of the airfoil portion so as to be interposed between the welded section and the fluid flow passage.

22. A turbine comprising a rotor which comprises the turbine blade according to claim 13.

23. A method of producing a turbine blade which comprises an airfoil portion disposed in a fluid flow passage of a turbine and a shroud portion having an opening with which an end portion of the airfoil portion is to be engaged, the method comprising:
a step of fitting the end portion of the airfoil portion into the opening of the shroud portion so that a cooling hole formed on at least one of the shroud portion or the airfoil portion has an opening into a clearance formed between a wall surface forming the opening of the shroud portion and an outer peripheral surface of the end portion of the airfoil portion; and
a step of welding the wall surface of the shroud portion and the outer peripheral surface of the airfoil portion at an opposite side to the flow fluid passage across the cooling hole,
wherein the welding step includes forming a welded section in the clearance only on an opposite side to the fluid flow passage as seen from the cooling hole so that the clearance remains at least at an opening position of the cooling hole and at a side closer to the fluid flow passage than the opening position.

24. The method of producing a turbine blade according to claim 23, further comprising a casting step of casting each of the airfoil portion and the shroud portion separately.

25. The method of producing a turbine blade according to claim 23,
wherein the shroud portion includes an inner shroud and an outer shroud disposed on a first side and a second side of the airfoil portion, respectively, each of the inner shroud and the outer shroud having the opening,
wherein the fitting step includes fitting each end portion of the airfoil portion into the opening of each of the inner shroud and the outer shroud so that the cooling hole has an opening into the clearance formed between the wall surface forming the opening of each of the inner shroud and the outer shroud and the outer peripheral surface of each end portion of the airfoil portion, and
wherein the welding step includes welding the wall surface of each of the inner shroud and the outer shroud and the outer peripheral surface of each end portion of the airfoil portion on the opposite side to the fluid flow passage across the cooling hole.

26. The method of producing a turbine blade according to claim 23,
wherein the cooling hole has an opening into the clearance for permitting deformation of the shroud portion and the airfoil portion, the clearance being formed between the wall surface of the shroud portion and the outer peripheral surface of the airfoil portion so as to be interposed between the welded section and the fluid flow passage.
